(19) United States
(12) Patent Application Publication
(10) Pub. No.: US 2023/0297842 A1
(43) Pub. Date: Sep. 21, 2023

(54) METHOD AND SYSTEM FOR EVENT-TRIGGERED DISTRIBUTED REINFORCEMENT LEARNING FOR UNIT COMMITMENT OPTIMIZATION AND DISPATCH

(71) Applicant: SHANDONG UNIVERSITY, Jinan (CN)

(72) Inventors: Shuai LIU, Jinan (CN); Xiaowen WANG, Jinan (CN); Haoran ZHAO, Jinan (CN); Bo SUN, Jinan (CN); Lantao XING, Jinan (CN); Xian LI, Jinan (CN); Ruiqi WANG, Jinan (CN)

(73) Assignee: SHANDONG UNIVERSITY, Jinan (CN)

(21) Appl. No.: 18/124,251

(22) Filed: Mar. 21, 2023

(30) Foreign Application Priority Data
Mar. 21, 2022 (CN) 2022102745723

(51) Int. Cl. G06N 3/092; H02J 3/46

(52) U.S. Cl. CPC G06N 3/092; H02J 3/46

(57) ABSTRACT

A method for event-triggered distributed reinforcement learning for unit commitment optimization and dispatch to solve the waste problem of unit resources includes obtaining a unit commitment optimization and dispatch model, constructing a fixed action set under preset constraint conditions, and selecting optimal power of each unit; transforming constraint conditions into projection constraints, and projecting the virtual generation power to a corresponding constraint range, to obtain actual generation power of each unit within the constraint range; calculating corresponding rewards based on cost under actual generation power of each unit without bandwidth constraints, and updating local Q values of each unit in a Q table according to Q-learning algorithms, to obtain an optimal action of each unit without bandwidth constraints; and under the constraint conditions of considering bandwidths, obtaining an optimal solution, meeting limited bandwidth constraint conditions, to the unit commitment optimization and dispatch problem.

### TECHNICAL FIELD

The present invention belongs to the technical field of unit commitment optimization and dispatch of smart grids, and particularly relates to a method and system for event-triggered distributed reinforcement learning for unit commitment optimization and dispatch.

### BACKGROUND

The description in this part only provides technical background information related to the present invention, and is unnecessary to constitute the prior art.

The smart grid allows large-scale DC transmission and distributed generation to enter the system, which improves the power supply reliability and meets increased user demands for electricity. It takes reinforced structures as basis, intelligent applications as technical support, and harmonization and interaction as core characteristics. The smart grid has both advantages and challenges in development. The economy of system operation is a key consideration, and therefore the research on unit commitment optimization and dispatch is of great significance. The uncertainty of source, load and storage and complex dynamic characteristics of power grids are difficult to solve by traditional algorithms. While the unit commitment optimization and dispatch, serving as a random sequential decision problem, has same goals as reinforcement learning. Reinforcement learning has the advantages of no need of exact mathematical models, capability of achieving long-term return and the like. The use of reinforcement learning algorithms to solve unit commitment optimization and dispatch problems has received widespread attention of scholars. As the smart grid has distributed generation characteristics, centralized algorithms have not been applicable. The design principles of distributed control and collaboration of distributed reinforcement learning algorithms can effectively support safe and stable operation of new generation power grid units.

However, communication network bandwidths are limited in reality. When the grid system has a large quantity of units and transmits excessive messages, network congestion easily occurs, which delays message transmission and affects a dispatch effect. Conventional solutions are based on time triggering, that is, the triggering time is set in advance to transmit information periodically, which does not change depending on the system state or time dynamically. However, such solutions may still result in unnecessary waste of resources.

### SUMMARY

In order to solve the technical problem in the background, the present invention provides a method and system for event-triggered distributed reinforcement learning for unit commitment optimization and dispatch, which can improve the utilization rate of unit resources.

In order to achieve the above objective, the present invention provides the following technical solution:

A first aspect of the present invention provides a method for event-triggered distributed reinforcement learning for unit commitment optimization and dispatch, which includes:
obtaining a unit commitment optimization and dispatch model based on parameters of generator units of a smart grid, constructing a fixed action set under preset constraint conditions, and selecting optimal power, namely virtual generation power, of each unit;
transforming constraint conditions into projection constraints, and projecting the virtual generation power to a corresponding constraint range, to obtain actual generation power of each unit within the constraint range;
calculating corresponding rewards based on cost under actual generation power of each unit without bandwidth constraints, and updating local Q values of each unit in a Q table according to Q-learning algorithms, to obtain a globally optimal power solution, namely an optimal action, of each unit without bandwidth constraints; and
fixing the optimal action of each unit, and describing a communication bandwidth limit as a penalty threshold in a time period under the constraint conditions of considering bandwidths, to obtain an optimal solution, meeting limited bandwidth constraints, to a unit commitment optimization and dispatch problem.

A second aspect of the present invention provides a system for event-triggered distributed reinforcement learning for unit commitment optimization and dispatch, which includes:
a virtual generation power filtering module, configured to obtain a unit commitment optimization and dispatch model based on parameters of generator units of a smart grid, construct a fixed action set under preset constraint conditions, and select optimal power, namely virtual generation power, of each unit;
a constrained projection module, configured to transform constraint conditions into projection constraints, and project the virtual generation power to a corresponding constraint range, to obtain actual generation power of each unit within the constraint range;
a globally optimal solution solving module, configured to calculate corresponding rewards based on cost under actual generation power of each unit without bandwidth constraints, and update local Q values of each unit in a Q table according to Q-learning algorithms, to obtain a globally optimal power solution, namely an optimal action, of each unit without bandwidth constraints; and
a limited bandwidth constraint solving module, configured to fix the optimal action of each unit, and describe a communication bandwidth limit as a penalty threshold in a time period under the constraint conditions of considering bandwidths, to obtain an optimal solution, meeting limited bandwidth constraints, to a unit commitment optimization and dispatch problem.

Compared with the prior art, the present invention has the following beneficial effects:
(1) The event-triggered distributed reinforcement learning optimization algorithm can solve the unit commitment problem and dispatch problem simultaneously, and achieves minimization of the cost for unit commitment optimization and dispatch of the smart grid under the conditions of limited bandwidths and node constraints.
(2) According to the present invention, the limited bandwidth constraints are transformed into solving the optimization problem with constraints aiming at maximizing the sum of reward, to further solve the optimal information interaction strategy by neural networks, which provides new thoughts for solving the unit commitment optimization and dispatch problem under the limited bandwidths.
(3) The algorithms stated in the present invention can solve the problems of continuous action space and power load without using function approximation, and do not need mathematical expressions of cost functions of the units compared with consensus-based methods. Therefore, the algorithms can overcome the situation of nonconvexity and difficulty in precise characterization of cost functions, which are more realistic.

The advantages of the additional aspects of the present invention will be partially explained in the following description, part of which will become apparent from the following description, or understood through practice of the present invention.

### BRIEF DESCRIPTION OF THE DRAWINGS

Drawings of the specification constituting a part of the present invention are described for further understanding the present invention. Exemplary embodiments of the present invention and descriptions thereof are illustrative of the present invention, and are not construed as an improper limitation to the present invention.

FIG. 1 is a schematic diagram of event-triggered distributed reinforcement learning optimization for unit commitment optimization and dispatch in an embodiment of the present invention; and

FIG. 2 is a flow chart of a method for event-triggered distributed reinforcement learning for unit commitment optimization and dispatch in an embodiment of the present invention.

### DETAILED DESCRIPTION

The present invention will be further described below with reference to the drawings and the embodiments.

It should be noted that the following detailed descriptions are exemplary, which are intended to further explain the present invention. Unless otherwise indicated, all technical and scientific terms used here have the same meaning as commonly understood by a person of ordinary skill in the art to which the present invention pertains.

It is worthwhile to note that the terms used here are not intended to limit the exemplary implementations according to the present invention, but are merely descriptive of the specific implementation. Unless otherwise directed by the context, singular forms of terms used here are intended to include plural forms. Besides, it should be also appreciated that, when the terms “comprise” and/or “include” are used in the specification, it indicates that characteristics, steps, operations, devices, assemblies, and/or combinations thereof exist.

### Embodiment I

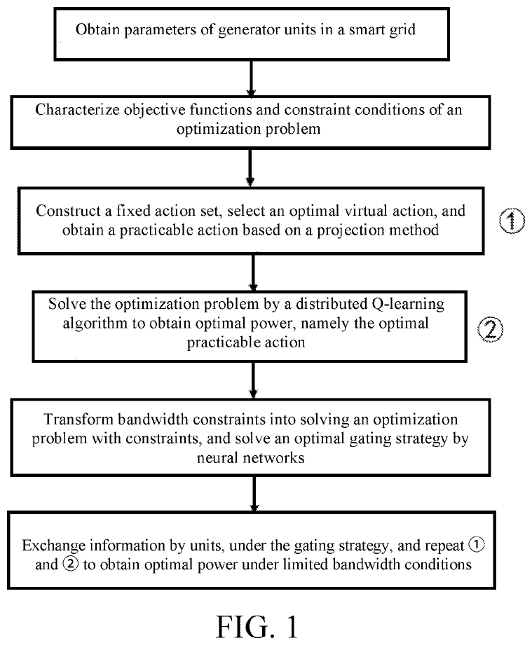

As shown in FIG. 1, this embodiment provides a method for event-triggered distributed reinforcement learning for unit commitment optimization and dispatch, which specifically includes:

S101: A unit commitment optimization and dispatch model is obtained based on parameters of generator units of a smart grid, a fixed action set is constructed under preset constraint conditions, and optimal power, namely virtual generation power, of each unit is selected.

A unified mathematical model for a unit commitment optimization and dispatch problem of the smart grid is constructed:

$$min {\sum }_{i = 1}^{T} {γ}^{t - 1} {{\sum }_{i = 1}}^{N} {F}_{i} ( {S}_{i , t} , {P}_{i , t} )$$

The main objective of this problem is to find a cost-optimal dispatch solution in a period T, where N is the quantity of units, γϵ(0,1] is a discount factor, δ_{i,t} is the state of the unit i at time t, P_{i,t} is the output power of the unit i at time t;

Fᵢ(⋅)=Cᵢ(P_{i,t})I_{i,t}+C_{i,SU}(t)+C_{i,SD}(t) is the generating cost of the unit i at time t, Cᵢ(P_{i,t}) is the cost of output power P_{i,t} of the unit i at time t, I_{i,t} represents a dispatch participation index of the unit i at time t; if the unit i participates at time t, I_{i,t}=1, or else I_{i,t}=0; C_{i,SD}(t) presents the possible shutdown cost of the unit i at time t; and C_{i,SU}(t) represents the hot start-up cost of the unit i at time t.

$${S}_{i , t} = \{ \begin{matrix}\{ {P}_{i , 0} \} , & if t = 1 \\ \{ {I}_{i , 0} , … , {I}_{i , t - 2} , {P}_{i , i - 1} \} , & if 2 \leq t < {T}_{i} \\ \{ {I}_{i , t - {T}_{i}} , … , {I}_{i , t - 2} , {P}_{i , t - 1} \} , & if t \geq {T}_{i}\end{matrix}$$

Where Tᵢ=max {T_{i,u}, T_{i,D}, T_{i,b2c}}, T_{i,U} is the minimum start-up time of the unit i, T_{i,D} is the minimum downtime of the unit i, T_{i,b2c} is the cooling time of the unit i, P_{i,0} and I_{i,0} are the initial output power and initial output current of the unit i, Tᵢ is a dispatching period of the unit i, P_{i,t-1} is the output power of the unit i at time t−1; I_{i,t-2} is the output current of the unit i at time t−2, and I_{i,t-T}_{ᵢ} is the output current of the unit i at time t−Tᵢ.

The above optimization objectives should meet the following constraint conditions:

(1) Supply-demand balance constraint

$$s . t . {\sum }_{i = 1}^{N} {P}_{i , t} = {D}_{t} + {P}_{L , t} ∀ t = 1 , … , T$$

Where, Dₜ is the total power demand, and P_{L,t} is the transmission line loss at time t.

(2) No-working areas

Pᵢϵ{[P_{i,m}_{ᵢ}₋₁,P_{i,m}_{ᵢ}]|mᵢ=2, . . . , Mᵢ}

Where:
P_{i,t}=Pᵢ, P_{i,M}=P̅ᵢ, Pᵢ and P̅ᵢ are the maximum and minimum power outputs that the unit participates, P_{i,m}_{ᵢ}₋₁,P_{i,m}_{ᵢ} are mᵢ−1 and mᵢ no-working areas respectively, and Mᵢ is the quantity of the no-working areas.

(3) Minimum start-up-stop time constraint

(X_{i,ON}(t−1)−T_{i,U})(I_{i,t-1}−I_{i,t})≥0

(T_{i,D}−X_{i,OFF}(t−1)(I_{i,t-1}−I_{i,t})≥0

Where, T_{i,U} is the minimum start-up time of the unit i, X_{i,ON}(t−1) is the continuous participation time interval of the unit i; X_{i,OFF}(t) is the continuous exit time of the unit i, and T_{i,D} is the minimum downtime of the unit i

(4) Power ramp constraint

|(P_{i,t}−P_{i,t-1})I_{i,t}I_{i,t-1}|≤pᵢ^{R}

Where, Pᵢ^{R} is a ramp-up and down limit.

(5) Generating capacity constraint

PᵢI_{i,t}≤P_{i,t}≤P̅ᵢI_{i,t}

(6) Spinning reserve constraint

$${\sum }_{i = 1}^{N} {\underline{P}}_{i} {I}_{i , t} - {P}_{L , t} - {D}_{t} \leq {\underline{R}}_{t}$$

$${\sum }_{i = 1}^{N} {\overline{P}}_{i} {I}_{i , t} - {P}_{L , t} - {D}_{t} \geq {\overline{R}}_{t}$$

Where, Rₜ and R̅ₜ are the minimum and maximum spinning reserves respectively; Dₜ=[D_{1,t} D_{2,t}, . . . , D_{N,t}]^{T} represents the total power demand of each unit at time t.

S102: Constraint conditions are transformed into projection constraints, and the virtual generation power is projected to a corresponding constraint range, to obtain actual generation power of each unit within the constraint range.

The total power demand Dₜ at time t is estimated by the following average consensus algorithm:

\dot{D}ₜ=−LDₜ

Where:

Dₜ=[D_{1,t}, D_{2,t}, . . . , D_{N,t}]^{T}, L is a Laplacian matrix of a graph G.

The reward rₜ at time t is defined as:

$${r}_{t} = K - \frac{1}{N} {γ}^{t - 1} {{\sum }^{N}}_{i = 1} {F}_{i} ( {S}_{i , t} , {P}_{i , t} )$$

Where, K is a positive constant.

A fixed discrete virtual action set, namely a virtual generation power set, is set by dividing a capacity constraint interval. The m^{th} action a_{i,t}^{m} of the unit i at time t is defined as:

$${a}_{i , t}^{m} = {\underline{P}}_{i} + m ( \frac{{\overline{P}}_{i} - {\underline{P}}_{i}}{M} )$$

The actual generation power should be within the capacity constraint interval. The actual action a′ₜ in initial space is given as {a′ₜϵ [symbol] ^{N}|PᵢI_{i,t}≤a′_{i,t}≤P̅ᵢI_{i,t}, i=1, 2, . . . , N}, and the state space is defined as the actual action space {sᵢϵ [symbol] ^{N}|PᵢI_{i,t}≤s_{i,t}≤P̅ᵢI_{i,t}, i=1, 2, . . . , N}, where s_{i,t} is the state of the unit i at time t.

A virtual action is selected as the optimal action a*_{i,j} in the virtual action set according to the probability 1−μ:

a*_{i,t}=argmaxₐ_{_{i,t}}Q(s_{i,t},a_{i,t})

and selected as other actions according to the probability μ. Where, a_{i,t} is the action of the unit i at time t.

The practicable action is solved by a constrained projection method, and a detailed description of this problem is given.

$$min {‖ {a}_{t}^{′} - {a}_{t} ‖}_{{L}_{2}} = \frac{1}{2} {\sum }_{i = 1}^{N} {( {a}_{i , t}^{′} - {a}_{i , t} )}^{2}$$

$$s . t . {h}_{t} = {D}_{t} - {\sum }_{i = 1}^{N} {a}_{i , t}^{′} = 0$$

$${g}_{i , t} = {a}_{i , t}^{′} - min ( \overline{{P}_{i}} , {a}_{i , t - 1}^{′} + {p}_{i}^{R} ) \leq 0$$

$${l}_{i , t} = - {a}_{i , t}^{′} + max ( {\underline{P}}_{i} , {a}_{i , t - 1}^{′} - {p}_{i}^{R} ) \leq 0$$

A distributed singular perturbed dynamics is solved to obtain the solution to the above problem, namely the actual generation power. h₁ is an equality constraint, and both g_{i,t} and l_{i,t} are inequality constraints ∥⋅∥_{L}_{₂} is the norm of L.

S103: Corresponding rewards are calculated based on cost under actual generation power of each unit without bandwidth constraints, and local Q values of each unit in a Q table are updated according to Q-learning algorithms, to obtain a globally optimal power solution, namely an optimal action, of each unit without bandwidth constraints.

Environment is observed to obtain the cost Fᵢ(a′_{i,t}) under the actual generation power of each unit, and τᵢϵR^{N} and ζᵢϵR^{N} are defined as:

$${\dot{ξ}}_{i} = - κ {ξ}_{i} - {\sum }_{j = 1}^{N} {μ}_{ij} ( {ξ}_{i} - {ξ}_{j} ) + {\sum }_{j = 1}^{N} {μ}_{ji} ( {ζ}_{i} - {ζ}_{j} ) + κ {F}_{i} ( {a}_{i , i}^{′} ) ,$$

$${\dot{ζ}}_{i} = - {\sum }_{j = 1}^{N} {μ}_{ij} ( {ξ}_{i} - {ξ}_{j} ) .$$

Where, κ>0 is an estimated parameter, μᵢⱼ is a neighbor weight from the unit edge i to j, and an unbiased estimator

$${ξ}_{i} = \frac{1}{N} {\sum }_{i = 1}^{N} {F}_{i} ( {a}_{i , t}^{′} )$$

is obtained by the above dynamic average consensus algorithm, to obtain the reward

$${r}_{t} = K - \frac{1}{N} {γ}^{t - 1} {\sum }_{i = 1}^{N} {F}_{i} ( {S}_{i , t} , {P}_{i , t} ) .$$

Local Q values of each unit in the Q table are updated according to the Q-learning algorithm:

$${Q}_{new} ( s , a ) = Q ( s , a ) + α ( r + γ {max}_{{a}^{′}} Q ( {s}^{′} , {a}^{′} ) - Q ( s , a ) )$$

Where, α is a learning rate, r represents the reward, s′ represents the state at next time, a′ represents the action at next time, s, a represent the state and action at the current time respectively, and [symbol] _{new}(s,a) represents the updated local Q values.

The power of each unit is optimized by the Q table, to obtain the globally optimal solution to the power of the unit.

S104: The optimal action of each unit is fixed, and a communication bandwidth limit is described as a penalty threshold in a time period under the constraint conditions of considering bandwidths, to obtain an optimal solution, meeting limited bandwidth constraints, to a unit commitment optimization and dispatch problem.

The optimal action obtained without bandwidth constraints is fixed, and the communication bandwidth limit is described as the penalty threshold C in a time period:

$$C = 𝔼 [ {\sum }_{t = 0}^{∞} {γ}^{′} 𝕀 ( {g}_{i , t} = 1 ) ] ⩽ \frac{{p}_{sup}}{1 - γ} = {C}_{sup}$$

Where, [symbol] [⋅] represents a penalty function; pₛᵤₚ is the upper limit of maximum probability permitted to send and receive information, Cₛᵤₚ represents the penalty threshold, [symbol] (g_{i,t}=1) represents the instantaneous penalty when the bandwidth is occupied, g_{i,t}˜μᵢ(m_{i,t},rm_{i,t-1},m_{i,\hat{t}}_{¹}) represents a gating strategy; m_{i,t} represents information obtained at time t, where rm_{i,t-1} is other information newly obtained before the time t−1, and m_{i,\hat{t}}_{¹} is the information received at the latest triggering time, and stored in a zero-order hold module;

$${\hat{t}}^{i} = {argmin}_{k ∈ {U}_{i , t - 1}} \{ t - k \} ,$$

$${U}_{i , t} = ( {t}_{0}^{i} , … , {t}_{r}^{i} , … )$$

U_{i,t} represents a set of event-triggered time instants tri at current time t.

The design of an event-triggering mechanism is transformed into solving the optimization problem with constraints aiming at maximizing the sum of reward.

$$max 𝔼 [ {\sum }_{t = 0}^{∞} {γ}^{t} {r}_{i , t} ]$$

$$s . t . 𝔼 [ {\sum }_{t = 0}^{∞} {γ}^{t} {g}_{i , t} ] ⩽ {C}_{sup}$$

Where, r_{i,t} is the reward of the unit i at time t.

The above problem is solved by training neural networks, to obtain the optimal gating strategy, namely the event-triggering mechanism. Thus, the event-triggered optimization method is obtained.

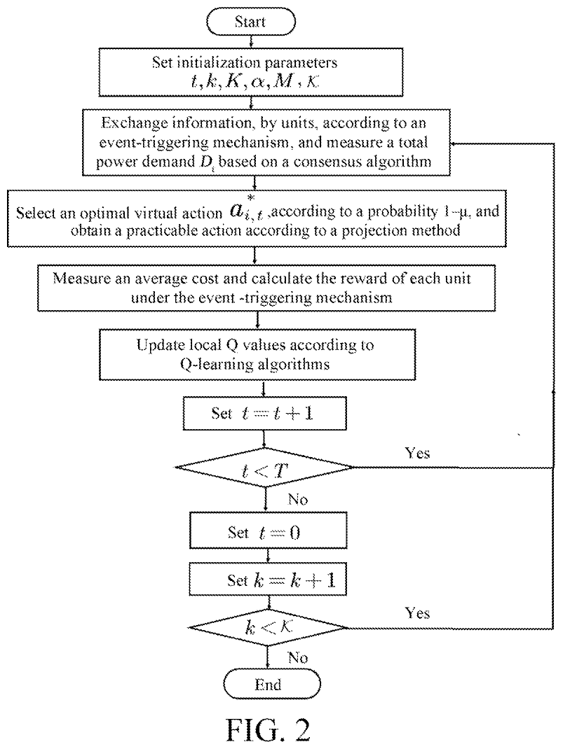

FIG. 2 is a flow chart of the algorithm, and specific steps are as follows:
Step 1: Initial parameters are set, as shown in Table 1, and the quantity of generator units is 4.

TABLE 1
Initial parameters

| Unit | Pᵢ (MW) | P̅ᵢ (MW) | aᵢ | bᵢ | cᵢ | eᵢ | fᵢ |
|---|---|---|---|---|---|---|---|
| G₁ | 300 | 500 | 0.0030 | 7 | 400 | 200 | 0.02 |
| G₂ | 100 | 600 | 0.0025 | 5 | 150 | 150 | 0.035 |
| G₃ | 50 | 300 | 0.0045 | 9 | 200 | 250 | 0.04 |
| G₄ | 200 | 400 | 0.0050 | 10 | 350 | 100 | 0.03 |

Initialization time is t=0, K=1.5, and the learning rate is α=0.95, M=15;
The cost function Fᵢ(Pᵢ) of a valve-point load in each unit is defined as:

Fᵢ(Pᵢ)=aᵢPᵢ²+bᵢPᵢ+cᵢ+|eᵢ·sin(fᵢ·(Pᵢ−Pᵢ))|
Where, aᵢ, bᵢ and cᵢ are generating cost coefficients, and eᵢ and fᵢ are coefficients of the valve-point load;
Step 2: The total power demand at time t is measured;
Step 3: The current state s_{i,t}=a′_{i,t-1} of each unit is identified;
Step 4: For the virtual action a_{i,t} of each unit, the optimal action a*_{i,t} is selected according to the probability 1−μ:

a*_{i,t}=argmaxₐ_{_{i,t}} [symbol] (s_{i,t},a_{i,t})
other actions are selected according to the probability μ;
Step 5: The actual action a′_{i,t}, namely the actual generation power, is obtained by a projection method;
Step 6: The average

$$cost \frac{1}{N} {\sum }_{i = 1}^{N} {F}_{i} ( {a}_{i , t}^{′} )$$

of each unit is estimated, and the reward

$${r}_{t} = K - \frac{1}{N} {γ}^{t - 1} {\sum }_{i = 1}^{N} {F}_{i} ( {S}_{i , t} , {P}_{i , t} )$$

of each unit is further calculated;
Step 7: The local Q values of each unit in the Q table are updated according to the following Q-learning algorithm.

The power of each unit is optimized by the Q table, to obtain the globally optimal solution to the power of each unit.
Step 8.1: Letting πᵢ=π*, that is, the action strategy is fixed as optimal, and the observed value mₜ is initialized;
Step 8.2: Gating gₜ is executed, and stored information m_{i,t′} and received information rm_{i,t} are updated;
Step 8.3: The action aₜ is executed, the reward rᵢ, observed value mₜ₊₁ and approximate global state vₜ₊₁ are observed, where v_{i,t}=[m_{i,t},m_{-i,t}];
Step 8.4: Information (m_{i,t}, m_{i,\hat{t}′},rm_{i,t-1},g_{i,t},rm_{i,t}r_{i,t},λₜ,mₜ₊₁,v′ₜ₊₁) are stored, where, v′ₜ₊₁=[vₜ₊₁,rmᵣ₊₁]; m_{i,t} is the current information of the unit i at time t; m_{i,\hat{t}′} is the information at the latest event-triggered time instant, rm_{i,t-1} is the information received no later than time t−1 in an event-triggered scenario, g_{i,t} is the gating action at time t, rm_{i,t} is the information received no later than time t, r_{i,t} is the reward at time t, λₜ is a Lagrange multiplier at time t, and v′ₜ₊₁ is the current information at time t+1;
Small batch samples (m_{i′,t′},m_{i′,\hat{t}′},rm_{i′,t′-1},g_{i′,t′},rm_{i′,t′},r_{i′,t′},λ_{t′},m_{t′+1},v′_{i′,t′+1}) are collected therefrom.
Step 8.5: The state value function

$${V}_{{θ}_{L}} ( {v}_{i , t}^{′} ) = 𝔼 [ {\sum }_{i = 1}^{N} {γ}^{t} {r}_{i , t}^{′} ]$$

of a gated neural network is estimated by updating the parameter θ_{L} of a Lagrange network based on small samples according to the following formula:

[symbol]

_{i,t}¹=δ_{L,i}²=(r′_{i,t}+γV_{θ}_{_{L}}(v′_{i,t+1})−V_{θ}_{_{L}}(v′_{i,t}))²
Where:
[symbol] _{i,t}¹ is the loss of the Lagrange network;
δ_{L,i}² is a TD error;
v′_{i,t}=[v_{i,t},rm_{i,t},rm_{-i,t}], rm_{-i,t}=[rm_{i,t}, . . . , rm_{i-1,t}, rm_{i+1,t}, . . . , rm_{N,t}]

The parameter θ_{g} of the gated network is updated based on the small samples according to the following formula:

[symbol]

_{i,t}^{g}=−log μᵢ(g_{i,t}|m_{i,t},rm_{i,t-1},m_{i,\hat{t}′},θ_{g})δ_{L,i}=−αH(μᵢ(g_{i,t}|m_{i,t},rm_{i,t-1},m_{i,\hat{t}′,θ}_{L}))

Where, [symbol] _{i,t}^{g} is the loss of the gated network; the penalty value function

$${V}_{{θ}_{p}} ( {v}_{i} ) = 𝔼 [ {\sum }_{i = 0}^{∞} {γ}^{t} {g}_{i , t} ]$$

of the gated neural network is estimated by updating the parameter θₚ of a penalty network based on the small samples according to the following formula;

[symbol]

_{i,t}^{p}=[g_{i,t}+γV_{θ}_{ₚ}(v′_{i,t+1})−V_{θ}_{ₚ}(v′_{i,t})]²
Where, [symbol] _{i,t}^{p} is the loss of the penalty network;
The parameter λₜ is updated according to the following formula:

λₜ₊₁=(λₜ−η_{λ}(−V_{θ}_{ₚ}+Cₛᵤₚ))⁺
where (x)⁺ represents truncation function, i.e. (x)⁺=max{x,0}, η_{λ} is a set parameter.
Step 8.6: The optimal gating strategy μ* is obtained; and
Step 9: Step 1 to step 7 are repeated, and information interaction is performed under the optimal gating strategy when step 2 and step 6 are executed, to solve the limited bandwidth problem, and the optimal solution to the unit commitment optimization and dispatch problem is obtained finally.

### Embodiment II

This embodiment provides a system for event-triggered distributed reinforcement learning for unit commitment optimization and dispatch, which includes:
a virtual generation power filtering module, configured to obtain a unit commitment optimization and dispatch model based on parameters of generator units of a smart grid, construct a fixed action set under preset constraint conditions, and select optimal power, namely virtual generation power, of each unit;
a constrained projection module, configured to transform constraint conditions into projection constraints, and project the virtual generation power to a corresponding constraint range, to obtain actual generation power of each unit within the constraint range;
a globally optimal solution solving module, configured to calculate corresponding rewards based on cost under actual generation power of each unit without bandwidth constraints, and update local Q values of each unit in a Q table according to Q-learning algorithms, to obtain a globally optimal power solution, namely an optimal action, of each unit without bandwidth constraints; and
a limited bandwidth constraint solving module, configured to fix the optimal action of each unit, and describe a communication bandwidth limit as a penalty threshold in a time period under the constraint conditions of considering bandwidths, to obtain an optimal solution, meeting limited bandwidth constraints, to a unit commitment optimization and dispatch problem.

It should be noted here that the modules in this embodiment correspond to the steps in Embodiment I one by one, and the specific implementation processes are the same, and will not be described here.

The present invention is described with reference to flow charts and/or block diagrams of the method, equipment (system) and computer program products in the embodiments of the present invention. It should be understood that each flow and/or block in the flow charts and/or the block diagrams and/or combinations of the flows and/or blocks in the flow charts and/or the block diagrams may be implemented by computer program instructions. These computer program instructions may be supplied to a general computer, a special-purpose computer, an embedded processing unit or a processing unit of other programmable data processing equipment to enable a machine, so that the instructions executed by the computer or the processing unit of other programmable data processing equipment enable a device for implementing functions specified in one or more flows in the flow charts and/or one or more blocks in the block diagrams.

The above description is only the preferred embodiments of the present invention and is not intended to limit the present invention, and those skilled in the art can make various modifications and variations on the present invention. Any modification, equivalent replacement, improvement, and the like made within the spirit and principle of the present invention should fall within the protection scope of the present invention.

What is claimed is:

1. A method for event-triggered distributed reinforcement learning for unit commitment optimization and dispatch, comprising:
obtaining a unit commitment optimization and dispatch model based on parameters of generator units of a smart grid, constructing a fixed action set under preset constraint conditions, and selecting optimal power, namely virtual generation power, of each unit;
transforming constraint conditions into projection constraints, and projecting the virtual generation power to a corresponding constraint range, to obtain actual generation power of each unit within the constraint range;
calculating corresponding rewards based on cost under actual generation power of each unit without bandwidth constraints, and updating local Q values of each unit in a Q table according to Q-learning algorithms, to obtain a globally optimal power solution, namely an optimal action, of each unit without bandwidth constraints; and
fixing the optimal action of each unit, and describing a communication bandwidth limit as a penalty threshold in a time period under the constraint conditions of considering bandwidths, to obtain an optimal solution, meeting limited bandwidth constraints, to a unit commitment optimization and dispatch problem.

2. The method for event-triggered distributed reinforcement learning for unit commitment optimization and dispatch according to claim 1, wherein an expression of the unit commitment optimization and dispatch model is defined as:
$$min {\sum }_{t = 1}^{T} {γ}^{t - 1} {\sum }_{i = 1}^{N} {F}_{i} ( {S}_{i , t} , {P}_{i , t} )$$
where, γϵ(0,1] is a discount factor, T is the end time, Fᵢ(⋅)=Cᵢ(P_{i,t})I_{i,t}+C_{i,SU}(t)+C_{i,SD}(t) is generating cost of the unit i at time t; Cᵢ(P_{i,t}) is cost of output power P_{i,t} of the unit i at time t; I_{i,t} represents a dispatch participation index of the unit i at time t; if the unit i participates at time t, I_{i,t}=1, or else I_{i,t}=0; C_{i,SD}(t) is possible shutdown cost of the unit i at time t; C_{i,SU}(t) is hot start-up cost of the unit i at time t; S_{i,t} represents the state of the unit i at time t; P_{i,t} is output power of the unit i at time t; and N is the quantity of the units.

3. The method for event-triggered distributed reinforcement learning for unit commitment optimization and dispatch according to claim 2, wherein an expression of the state S_{i,t} of the unit i at time t is defined as:
$${S}_{i , t} = \{ \begin{matrix}\{ {P}_{i , 0} \} , & if t = 1 \\ \{ {I}_{i , 0} , … , {I}_{i , t - 2} , {P}_{i , t - 1} \} , & if 2 ⩽ t < {T}_{i} \\ \{ {I}_{i , t - {T}_{1}} , … , {I}_{i , t - 2} , {P}_{i , t - 1} \} , & if t ⩾ {T}_{i}\end{matrix}$$
where Tᵢ=max{T_{i,U},T_{i,D},T_{i,b2c}}, T_{i,U} is minimum start-up time of the unit i, T_{i,D} is minimum downtime of the unit i, T_{i,b2c} is cooling time of the unit i, P_{i,0} and I_{i,0} are initial output power and initial output current of the unit i, Tᵢ is the dispatching period of the unit i, P_{i,t-1} is output power of the unit i at time t−1; I_{i,t-2} is output current of the unit i at time t−2, and I_{i,t-T}_{ᵢ} is output current of the unit i at time t−Tᵢ.

4. The method for event-triggered distributed reinforcement learning for unit commitment optimization and dispatch according to claim 1, wherein the preset constraint conditions comprise a supply-demand balance constraint, no-working areas, a minimum start-up-stop time constraint, a power ramp constraint, a generating capacity constraint and a spinning reserve constraint.

5. The method for event-triggered distributed reinforcement learning for unit commitment optimization and dispatch according to claim 1, wherein after the communication bandwidth limit is described as the penalty threshold in a time period, the method further comprises:
transforming the design of an event-triggering mechanism into solving the optimization problem with constraints aiming at maximizing the sum of reward, and solving the above problem by training neural networks, to obtain the optimal gating strategy, namely the event trigger-triggering mechanism.

6. A system for event-triggered distributed reinforcement learning for unit commitment optimization and dispatch, comprising:
a virtual generation power filtering module, configured to obtain a unit commitment optimization and dispatch model based on parameters of generator units of a smart grid, construct a fixed action set under preset constraint conditions, and select optimal power, namely virtual generation power, of each unit;
a constrained projection module, configured to transform constraint conditions into projection constraints, and project the virtual generation power to a corresponding constraint range, to obtain actual generation power of each unit within the constraint range;
a globally optimal solution solving module, configured to calculate corresponding rewards based on cost under actual generation power of each unit without bandwidth constraints, and update local Q values of each unit in a Q table according to Q-learning algorithms, to obtain a globally optimal power solution, namely an optimal action, of each unit without bandwidth constraints; and
a limited bandwidth constraint solving module, configured to fix the optimal action of each unit, and describe a communication bandwidth limit as a penalty threshold in a time period under the constraint conditions of considering bandwidths, to obtain an optimal solution, meeting limited bandwidth constraints, to a unit commitment optimization and dispatch problem.

7. The system for event-triggered distributed reinforcement learning for unit commitment optimization and dispatch according to claim 6, wherein an expression of the unit commitment optimization and dispatch model is defined as:
$$min {\sum }_{t = 1}^{T} {γ}^{t - 1} {\sum }_{i = 1}^{N} {F}_{i} ( {S}_{i , t} , {P}_{i , t} )$$
where, γϵ(0,1] is a discount factor, T is the end time, Fᵢ(⋅)=Cᵢ(P_{i,t})I_{i,t}+C_{i,SU}(t)+C_{i,SD}(t) is the generating cost of the unit i at time t; Cᵢ(P_{i,t}) is the cost of output power P_{i,t} of the unit i at time t; I_{i,t} represents a dispatch participation index of the unit i at time t; if the unit i participates at time t, I_{i,t}=1, or else I_{i,t}=0; C_{i,SD}(t) is the possible shutdown cost of the unit i at time t; C_{i,SU}(t) is the hot start-up cost of the unit i at time t; S_{i,t} represents the state of the unit i at time t; P_{i,t} is the output power of the unit i at time t; and N is the quantity of the units.

8. The system for event-triggered distributed reinforcement learning for unit commitment optimization and dispatch according to claim 7, wherein an expression of the state S_{i,t} of the unit i at time t is defined as:
$${S}_{i , t} = \{ \begin{matrix}\{ {P}_{i , 0} \} , & if t = 1 \\ \{ {I}_{i , 0} , … , {I}_{i , t - 2} , {P}_{i , t - 1} \} , & if 2 ⩽ t < {T}_{i} \\ \{ {I}_{i , t - {T}_{1}} , … , {I}_{i , t - 2} , {P}_{i , t - 1} \} , & if t ⩾ {T}_{i}\end{matrix}$$
where Tᵢ=max{T_{i,U},T_{i,D},T_{i,b2c}}, T_{i,U} is the minimum start-up time of the unit i, T_{i,D} is the minimum downtime of the unit i, T_{i,b2c} is the cooling time of the unit i, P_{i,0} and I_{i,0} are the initial output power and initial output current of the unit i, Tᵢ is a dispatching period of the unit i, P_{i,t-1} is the output power of the unit i at time t−1; I_{i,t-2} is the output current of the unit i at time t−2, and I_{i,t-T}_{ᵢ} is the output current of the unit i at time t−Tᵢ.

9. The system for event-triggered distributed reinforcement learning for unit commitment optimization and dispatch according to claim 6, wherein the preset constraint conditions comprise a supply-demand balance constraint, no-working areas, a minimum start-up-stop time constraint, a power ramp constraint, a generating capacity constraint and a spinning reserve constraint.

10. The system for event-triggered distributed reinforcement learning for unit commitment optimization and dispatch according to claim 6, wherein after the communication bandwidth limit is described as the penalty threshold in a time period, the limited bandwidth constraint solving module is further configured to:
transform the design of an event-triggering mechanism into solving the optimization problem with constraints aiming at maximizing the stun of reward, and solve the above problem by training neural networks, to obtain the optimal gating strategy, namely the event trigger-triggering mechanism.
